(19) United States
(12) Patent Application Publication
(10) Pub. No.: US 2016/0037797 A1
(43) Pub. Date: Feb. 11, 2016

(54) METHOD FOR IMPROVING THE ORGANOLEPTIC PROPERTIES OF SORBITOL-BASED SUGAR-FREE CHEWING GUM

(71) Applicant: SYRAL BELGIUM NV, Aalst (BE)

(72) Inventors: Nadia CAMUEL, Marckolsheim (FR); Abdelfattah BENSOUISSI, Aalst (BE)

(21) Appl. No.: 14/776,712

(22) PCT Filed: Mar. 11, 2014
(86) PCT No.: PCT/IB2014/059623

§ 371 Date: Sep. 14, 2015

(30) Foreign Application Priority Data
Mar. 12, 2013 (FR) 13/00549

(51) Int. Cl. A23G 4/10

(52) U.S. Cl. CPC A23G 4/10; A23V 2002/00

(57) ABSTRACT

A process for improving the organoleptic properties of sorbitol-based sugar-free chewing gums, such as the initial bite, the sweet-taste perception and the flavor intensity.

The present invention relates to a process for improving the organoleptic properties of sorbitol-based sugar-free chewing gums, such as the initial bite, the sweet-taste perception and the flavor intensity.

Chewing gum compositions generally comprise a base gum, a powdered sweetener, humectants and a flavoring agent, and also other optional ingredients such as plasticizers, fillers, colors, etc. When chewing gum compositions are formulated without sugars, the vast majority then comprise sorbitol. This sorbitol is incorporated in powder form. The sorbitol then acts as a sugar-free sweetener and as a filler.

It is well known that the characteristics of the sorbitol powder used have an effect on the ability to process the base gum during manufacture. Thus, softness and suppleness are necessary during the extrusion/rolling process. Moreover, when the chewing gum is cut into tablets, the gum should not be too soft or tacky, so as to avoid difficulties during cutting and packaging.

Methods for optimizing the texture and the processability of sugar-free chewing gum compositions containing sorbitol have already been described in the past. Such a process is described in WO 88/06845, in which at least two types of sorbitol powder are used in the formulation of gum compositions. The ratio between the two types of sorbitol powder is varied between the samples of different composition so as to optimize the texture and the ability to process the base gum. By varying the ratio between the two types of sorbitol, improvements in the processing and texture of the gum may be obtained. It should be noted that these sorbitol powders contain up to 75% of fine particles. Thus, the sorbitol powders mixtures proposed are liable to contain high levels of fine particles that are responsible, during the manufacture of the chewing gum, for an increase in the viscosity of the gum and in the mixing time of the gum with sorbitol.

In another publication, EP 0 725 567, the influence of the selection of the specific particle sizes of sorbitol on the softness or on the hardness of a chewing gum during transformation is discussed. Thus, commercially available sorbitol powders were screened so that the particles greater than 177 microns were to a large extent removed. Thus, a firmer chewing gum with more rapid stabilization is said to be obtained, conserving a gum which remains elastic enough to be rolled out. According to EP 0 725 567, the increased firmness is thus said to contribute toward increasing the efficiency of production and wrapping of soft chewing gums. However, since the sorbitol powders described in said document are powders with a high content of fine particles, they are also responsible for a long mixing time at high shear during the preparation of the chewing gums.

In addition to having an effect on the processing parameters, it is also acknowledged in WO 88/06845 that the release and perception of the sweet taste of a gum formulation may also be modified by means of these mixtures. The smallest particles dissolve more rapidly and develop an immediate sweet taste. The release of flavoring agents is also affected by the release of the sweet taste. Nevertheless, a large content of fine particles may also be perceptible in the chewing gum and lead to an increase in the firmness of the chewing gum in the mouth, which may prove to be unpleasant.

There is thus a need for a sorbitol powder having a particle size distribution which makes it possible both to increase the speed of mixing of the sorbitol with the base gum, but which also makes it possible to improve the organoleptic qualities of the chewing gum while at the same time maintaining its texture qualities.

The evaluation of chewing gum is difficult compared with other food products, since it involves changes in the tastes and textures during the tasting period. In the book “Formulation and Production of Chewing and Bubble Gum” by Fritz, Douglas (ISBN 0904725103), a process is described for evaluating chewing gum, which takes into account the various phases of chewing, and various parameters that are of importance during these various phases.

This method is considered to be the most reliable in the description of the various organoleptic aspects of chewing gum during its consumption. Consequently, this method is useful for identifying the potential weaknesses of certain gum formulations.

Nowadays, sugar-free chewing gum compositions, containing sorbitol as the major polyol, are manufactured using sorbitol powders which have a mean particle size of about 200 microns, as mentioned in “Formulation and Production of Chewing and Bubble Gum” by Fritz, Douglas, page 142.

This application is based on the observations made during the evaluation of the standard sorbitol powders used in the preparation of sugar-free chewing gum. Although the mean particle size of these powders is about 200 microns, it has been observed that it is nevertheless possible to find great variation in the particle size distribution of these powders.

Moreover, the inventors have shown that the distribution of these particles has an influence not only on the speed and ease of mixing of sorbitol with the base gum, but also on the taste, texture and flavor sensation of the chewing gum obtained.

Specifically, it has been demonstrated herein that a sorbitol powder with an excessively high content of fine particles makes the mixing of the base gum with the sorbitol powder particularly difficult and long, whereas an excessively small amount has a negative influence on the taste quality of the chewing gum. For the first time, such observations have been made from very small differences in fine particle contents between powders having comparable granulometric profiles.

Thus, it has been discovered, surprisingly, that a particular particle size distribution, even though the mean particle size remains at about 200 microns, has an effect considered as positive on a certain number of chewing gum properties, while at the same time maintaining the other taste characteristics of the chewing gum and reducing the mixing time of the base gum to obtain the chewing gum. The following particular properties were positively influenced:
the initial bite during the initial phase of chewing, which became slightly firmer;
the texture, which became smoother;
the sweet-taste perception and the flavor intensity during the intermediate phase;
improved freshness, when flavored with mint.

Thus, it was observed that there is an unachieved need to prepare novel chewing gums showing such effects.

On the basis of these results, the present invention is defined as being a sorbitol powder and also the use thereof for improving the organoleptic properties of chewing gum, in particular the initial bite, the texture, the sweet taste and the flavor intensity, the sorbitol powder having a particle size distribution, preferentially determined by particle size analysis using Retsch equipment, as follows:
from 0 to 1% by weight of particles >400 microns,
from 40% to 45% by weight of particles between 250 and 400 microns,
from 48% to 53% by weight of particles between 100 and 250 microns,
from 3.5% to 8% by weight of particles between 75 and 100 microns, and
from 0 to 2.5% by weight of particles <75 microns, the sum of the various fractions of which being 100% by weight.

The term “chewing gum” means a composition comprising an insoluble part consisting of the base gum and a soluble part comprising at least one polyol or a mixture of polyols, among which is a sorbitol powder according to the invention.

Various chewing gum formulations and the method for obtaining them are widely described in the prior art and especially in “Formulation and Production of Chewing and Bubble Gum” by Fritz, Douglas, page 142. In general, chewing gums are obtained by sequential addition of the various ingredients of the chewing gum (˜15-20 minutes) in a commercial blender well known to those skilled in the art, for example a jacketed blender allowing fine control of the temperature so as to allow softening of the base gum and regulation of the temperature of the chewing gum mass, for example at 50° C. during the process for obtaining the chewing gum.

More particularly, the term “chewing gum composition” means a composition comprising a base gum and optionally a filler such as a sweetener or a polyol (or sugar alcohol) chosen from sorbitol, maltitol, xylitol, lactitol, erythritol and isomalt, or a mixture thereof, at least one plasticizer chosen especially from a polyol syrup, glycerol and lecithin, or a mixture thereof, and at least one flavoring.

The term “filler” means a sweetener or a polyol, preferentially a mixture of polyols such as sorbitol and xylitol, sorbitol and maltitol or sorbitol and mannitol.

The term “chewing gum” means a composition comprising a base gum, a filler such as a sweetener or a polyol (or sugar alcohol) chosen, for example, from sorbitol, maltitol and xylitol, or a mixture thereof, at least one plasticizer chosen especially from a polyol syrup, glycerol and lecithin, or a mixture thereof, and at least one flavoring. Preferentially, the chewing gum comprises a base gum and the sorbitol powder according to the invention.

Preferentially, the chewing gum is sugar-free.

It has been demonstrated in the present application that the sorbitol powder according to the invention makes it possible to improve the organoleptic properties of chewing gums. In the present invention, the term “organoleptic property” means the set of sensory factors including the taste, the flavor and the texture. More particularly, it means the initial bite, the texture, the flavor intensity, the sweetness and the freshness.

The term “initial bite” means the force required for the teeth to penetrate the chewing gum when it is placed in the mouth, i.e. during the first seconds of consumption.

The term “flavor intensity” means the sensation of a flavor perceived retro-olfactively. The intensity measures the strength or weakness of a flavor during chewing of the chewing gum. A chewing gum with an excessively strong flavor intensity will be considered as “burning the tongue”, whereas an excessively weak intensity gives a sensation of “lacking flavor”.

The term “texture” of the chewing gum means the perception in the mouth of the smooth to granular aspect of the chewing gum when the chewing gum hydrated with saliva stimulates the sensory receptors located on the tongue.

The particle size distribution of the powder according to the invention may be measured using a Retsch screen, model AS200 control “g”, according to the manufacturer's recommendations. The use of this Retsch equipment for performing these analyses is well documented by the manufacturer and in the literature. More particularly, the sorbitol powders may be characterized in the following manner: 100 g of each of the powders are supplemented with 1 g of free-flowing agent such as silica (Sipernat® 22 S). The homogenized mass is screened with said equipment with an oscillation amplitude of 1.5 mm for 10 minutes. The various screens used (400, 250, 100 and 75 microns) according to this method are certified (ISO 3310-1). Each screen is then weighed so as to measure the weight of each of the particle size fractions and to calculate a percentage particle size distribution.

In a preferred embodiment, the particle size distribution, as determined by particle size analysis using Retsch equipment, is as follows:
from 0 to 1% by weight of particles >400 microns,
from 41% to 44% by weight of particles between 250 and 400 microns,
from 49% to 52% by weight of particles between 100 and 250 microns,
from 4% to 6% by weight of particles between 75 and 100 microns, and
from 0 to 1.5% by weight of particles <75 microns, the sum of the various fractions of which being 100% by weight.

The sorbitol powders that may be used according to the invention are obtained by milling and/or screening a crystalline sorbitol material. The milling and screening processes are well known to those skilled in the art. More particularly, the sorbitol powder according to the invention may be obtained by milling and then screening a crystalline sorbitol powder. The screening is preferentially performed successively on screens of 800 and 400 microns. The particles retained on the screens are milled and then screened again so as to obtain the desired particle size distribution. The fine particles may be removed by de-fining, generally in a fluidized bed. The mill used may be a paddle mill, hammer mill or pin mill. The screens used may be centrifugal or vibrating screens.

An example of a sorbitol powder that may allow the production of the powder according to the invention by milling and/or screening is a powder obtained from a sorbitol syrup by extrusion, atomization or agglomeration. Such powders are widely described in the prior art, for example GB 2 046 743 or EP 1 008 602. Such a process for milling and screening a crystalline sorbitol obtained by extrusion or pan-agglomeration is described, for example, in documents EP 0 669 130 and GB 2 046 743.

The invention furthermore relates to a method for improving the organoleptic properties of a chewing gum or for reducing the flavor content of a chewing gum, comprising the steps consisting in:
adding to a chewing gum composition at least one sorbitol powder having a particle size distribution, determined by particle size analysis using Retsch equipment, as follows:
from 0 to 1% by weight of particles >400 microns,
from 40% to 45% by weight of particles between 250 and 400 microns,
from 48% to 53% by weight of particles between 100 and 250 microns,
from 3.5% to 8% by weight of particles between 75 and 100 microns, and
from 0 to 2.5% by weight of particles <75 microns, the sum of the various fractions of which being 100% by weight, and
obtaining the chewing gum.

The invention also relates to a method for producing a chewing gum, comprising the steps consisting in:
mixing a base gum with a sorbitol powder having a particle size distribution, determined by particle size analysis using Retsch equipment, as follows:
from 0 to 1% by weight of particles >400 microns,
from 40% to 45% by weight of particles between 250 and 400 microns,
from 48% to 53% by weight of particles between 100 and 250 microns,
from 3.5% to 8% by weight of particles between 75 and 100 microns, and
from 0 to 2.5% by weight of particles <75 microns, the sum of the various fractions of which being 100% by weight, and
optionally, adding any one of the elements chosen from a plasticizer, a filler, a humectant, a flavoring, and a mixture thereof.

Preferentially, the method for producing a chewing gum furthermore comprises a step of extruding the chewing gum composition, a sprinkling step, a rolling step and a forming-cutting step.

The invention also relates to a chewing gum obtained by performing the method according to the invention.

The invention also relates to a chewing gum comprising the sorbitol powder according to the invention, said chewing gum preferentially having a reduced content of flavoring.

A chewing gum that is preferred according to the invention comprises 2% to 85% (w/w), preferably 5% to 84%, 10% to 80%, 15% to 75%, 20% to 70%, 25% to 65%, 30% to 60%, 45% to 55% (w/w) of sorbitol powder according to the invention.

Typically, a chewing gum according to the invention may comprise:
20-35% and preferentially 25-30% by weight of base gum;
5% to 25% and preferentially 10-15% by weight of plasticizer and
0.5-10% and preferentially 0.7% to 9%; 1% to 8%; 1.5% to 7%; 2% to 6%; 4% to 5% by weight (w/w) of flavoring.

The base gum may be any commercially available base gum suitable for the preparation of chewing gums, for example the base gum sold by Cafosa Gum S/A under the name Geminis-T.

The chewing gum may comprise, in addition to the sorbitol powder according to the invention, a polyol syrup, preferentially a maltitol syrup.

Typically, the chewing gum according to the invention comprises base gum, sorbitol powder according to the invention, a syrup, preferentially maltitol syrup, and optionally a xylitol and/or maltitol powder.

Preferentially, the chewing gum according to the invention may comprise:
from 20% to 35% (w/w) of base gum,
2% to 77% (w/w) of sorbitol powder according to the invention,
3% to 15% (w/w) of polyol syrup, preferentially of maltitol syrup,
optionally a xylitol and/or maltitol powder, more particularly 3% to 15% (w/w) of xylitol and/or maltitol powder.

### EXAMPLE

The organoleptic evaluation of chewing gums containing sorbitol powders mentioned above was performed using the chewing gum evaluation method as described on pages 81 and 85 of the book “Formulation and Production of Chewing and Bubble Gum” (ISBN=0904725103).

The chewing gum test composition is represented in Table 1:

TABLE 1
Compositions of the chewing gums.

| Chewing gum ingredients | Amount (g/100 g) |
|---|---|
| Sorbitol powder | 54.2 |
| Xylitol powder | 4.8 |
| Gum base Cafosa Geminis-T | 30.7 |
| Maltitol powder | 3.3 |
| Maltitol syrup (solids: 80%) | 7.0 |
| Mint flavoring Mane | qs |

Various sorbitol powders were tested, showing a particle size distribution as represented in Table 2:

TABLE 2
Particle size distribution of the evaluated samples.

| Particle | | Screened | Screened | Commercial | Screened |
|---|---|---|---|---|---|
| size | Reference | product 1 | product 2 | product | product 3 |
| >400μ | 0.9 | 0.9 | 0.6 | 7 | 1.4 |
| 250-400μ | 28.7 | 42.8 | 43.6 | 26 | 50.5 |
| 100-250μ | 53.8 | 51.1 | 50.3 | 49.7 | 44.3 |
| 75-100μ | 10.8 | 4.7 | 4.1 | 10.4 | 3.1 |
| <75μ | 5.8 | 0.5 | 1.4 | 6.9 | 0.8 |

Reference: Merisorb® 200 sold by Tereos Syral.
Commercial product: Neosorb P60W sold by Roquette Frères.

Analysis of the particle size distribution of the powders is performed using a Retsch screen, model AS200 control “g”, in accordance with the manufacturer's instructions, more particularly, in the following manner: 100 g of each of the powders are supplemented with 1 g of silica (Sipernat® 22S). The homogenized mass is screened with said equipment with an oscillation amplitude of 1.5 mm for 10 minutes. Each screen is then weighed so as to measure the weight of each of the particle size fractions and to calculate a percentage particle size distribution.

During the manufacture of the chewing gums, it was noted that, in comparison with the reference powder and the commercial powder, screens 1 and 2 allow a reduction in the mixing time of the composition in the chewing gum mixer. This constitutes an advantage of screens 1 and 2 according to the invention in comparison with all of the powders tested.

Once the chewing gums were obtained, the criteria relating to the appearance of the chewing gum (smooth surface without holes, well-defined edges) were measured. The results observed are similar between the screened materials, the reference powder and the commercial powder.

The sensory evaluation of the chewing gums was the subject of a strict protocol performed by a panel specifically trained for the tasting of chewing gums. The chewing gum tasting protocol is documented, and is more particularly described in “Formulation and production of chewing and bubble gum” by Douglas Fritz (Kennedys Books Ltd)—Hardcover (2008). This protocol is organized in three phases.

The initial phase corresponds to the bite in the mouth for the first 10 seconds of tasting; the intermediate phase up to 3 minutes precisely describes the sensory properties of the chewing gum in terms of hydration, texture and flavor perception, since it is during this period that most of the flavorings and sweeteners are extracted from the matrix. The final phase beyond 3 minutes characterizes the degree of stability of the chewing gum properties over time, mainly in terms of consistency and flavor perception.

The organoleptic parameters were evaluated by a trained panel composed of 9 people.

During the initial phase (first 10 seconds), the initial bite, the cohesion, the speed of perception and the flavor intensity are evaluated. During the intermediate phase (10 seconds to 3 minutes) the hydration (time taken by the matrix to absorb saliva), the cohesion, the texture, the tackiness on the teeth, the flavor intensity, the sweetness and the refreshing power are evaluated. Finally, during the final phase (3 to 6 minutes), the hardness, the texture, the tackiness on the teeth, the size of the chewing gum in the mouth, the form in the mouth (between two chews), the consistency, the width of the line when the chewing gum is drawn, the flavor intensity, the sweetness and, finally, the refreshing power are evaluated. The evaluation system uses a 5-point system corresponding to five grades or scores for each of the descriptors. The set of parameters defined above were tested (initial phase, intermediate phase and final phase). The scores and the set of parameters tested are described in the above reference.

During its analysis, the panel noted that, among the set of parameters measured, many parameters were maintained by using the screened materials in comparison with the reference powders and the commercial powder.

Only the parameters for which a difference is observed are detailed below. The scores for the parameters tested are defined in the system as below (Table 3).

In the table, P1 corresponds to the initial phase (first 10 seconds) and P2 to the intermediate phase (between 10 seconds and 3 minutes):

TABLE 3

| | Score | 1 | 2 | 3 | 4 | 5 |
|---|---|---|---|---|---|---|
| P1 | Initial bite | Firm | | normal | | Soft |
| P2 | Texture | Granular | | | | Smooth |
| P2 | Flavor intensity | Lack of flavor | | normal | | Burns the tongue |
| P2 | Sweetness | Little | | normal | | Lots |
| P2 | Refreshing power | Little | | normal | | Lots |

The modified values obtained by the trained panel are given in Table 4.

TABLE 4
Organoleptic evaluation.

| | | Screened | Screened | Commercial | Screened |
|---|---|---|---|---|---|
| | Reference | product 1 | product 2 | product | product 3 |
| Initial bite | 3.1 | 2.3 | 2.4 | 3.7 | 2.4 |
| Texture | 3.2 | 3.5 | 3.5 | 3.0 | 2.7 |
| Flavor | 3.6 | 4.3 | 4.0 | 3.7 | 2.5 |
| intensity | | | | | |
| Sweetness | 3.0 | 3.3 | 3.4 | 3.2 | 2.9 |
| Freshness | 3.3 | 4.0 | 3.7 | 3.4 | 2.5 |

In the case of the screened products 1, 2 and 3, a marked increase in the initial bite is observed, in the initial phase (first 10 seconds) compared with the reference powder and the commercial powder.

In the intermediate phase (between 10 seconds and 3 minutes), intensification of the flavor intensity, of the sweetness and of the freshness is observed for the screened products 1 and 2, but not for the screened product 3 when compared with the reference powder and the commercial powder. The effect of the particle distribution, as described in Table 2, is clear and sharp.

However, there is a limit to this screening process. In the case where the product is too screened, as in the case of the screened product 3, the initial bite remains identical, but the flavor perception and the freshness are clearly negatively affected when compared with the screened products 1 and 2, but even more so when compared with the reference and with the commercial product.

Thus, the screened products 1 and 2 are particularly advantageous in that the improvement of the flavor intensity of the chewing gum by the use of these powders makes it possible, for the same amount of sorbitol in the chewing gum, to reduce the amount of flavoring to obtain an identical flavor perception.

The screened products 1 and 2 also make it possible to perceive greater sweetness and also greater freshness than for the reference and commercial sorbitols, which makes it possible to intensify the flavor of the chewing gum obtained.

The effect of the particle size distribution of sorbitol powders on the flavor perception, the sweetness and the freshness of the chewing gum obtained is thus demonstrated for the first time.

It will also be noted that the variation in the particle size distribution of the screened product 3, in addition to reducing the flavor intensity, the sweetness and the freshness of the known sorbitols, also gives the chewing gum a granular structure, which is not desired since this sensation is unpleasant on the tongue.

This test also demonstrates that the reduction in fine particles does, admittedly, improve the organoleptic characteristics of the chewing gum, but that this reduction in fines must satisfy certain criteria. In other words, the sorbitol powder must not be excessively de-fined in order for the improvement of the organoleptic characteristics of the chewing gum to be observed.

Thus, a very fine difference in particle size of the sorbitol powder leads to detectable effects on the final chewing gum as regards the granular nature of the chewing gum in the mouth or the flavor perception, the sweetness or the freshness (screened product 1 or 2 versus screened product 3).

More specifically, the present example demonstrates that the powder according to the invention makes it possible, in comparison with the commercial sorbitol powders, i) to reduce the mixing times to obtain chewing gums when compared with the reference products, and ii) to obtain a chewing gum with improved initial bite, texture, flavor intensity, sweetness and freshness, iii) while at the same time maintaining the characteristics of the chewing gum such as the cohesion, the speed of perception, the hydration, the texture, the tackiness or the consistency.

1. The use of a sorbitol powder for improving the organoleptic properties of a chewing gum, wherein the sorbitol powder has a particle size distribution, determined by particle size analysis using Retsch equipment, as follows:
from 0 to 1% by weight of particles >400 microns,
from 40% to 45% by weight of particles between 250 and 400 microns,
from 48% to 53% by weight of particles between 100 and 250 microns,
from 3.5% to 8% by weight of particles between 75 and 100 microns, and
from 0 to 2.5% by weight of particles <75 microns, the sum of the various fractions of which being 100% by weight.

2. The use as claimed in claim 1, wherein said organoleptic properties are chosen from initial bite, texture, sweet taste and/or flavor intensity.

3. The use as claimed in claim 1, wherein the sorbitol powder has a particle size distribution as follows:
from 0 to 1% by weight of particles >400 microns,
from 41% to 44% by weight of particles between 250 and 400 microns,
from 49% to 52% by weight of particles between 100 and 250 microns,
from 4% to 6% by weight of particles between 75 and 100 microns, and
from 0 to 1.5% by weight of particles <75 microns, the sum of the various fractions of which being 100% by weight.

4. The use as claimed in claim 1, wherein said sorbitol powder is obtained by milling and/or screening crystalline sorbitol material.

5. A method for improving organoleptic properties and/or for reducing the content of flavoring of a chewing gum, comprising the steps consisting of:
adding to a chewing gum composition at least one sorbitol powder with a particle size distribution, determined by particle size analysis using Retsch equipment, as follows:
from 0 to 1% by weight of particles >400 microns,
from 40% to 45% by weight of particles between 250 and 400 microns,
from 48% to 53% by weight of particles between 100 and 250 microns,
from 3.5% to 8% by weight of particles between 75 and 100 microns, and
from 0 to 2.5% by weight of particles <75 microns, the sum of the various fractions of which being 100% by weight, and
obtaining chewing gum.

6. The method as claimed in claim 5, wherein the sorbitol powder added represents 5-85% by weight of the chewing gum.

7. A method for producing a chewing gum, comprising the following steps consisting of:
mixing a base gum with a sorbitol powder having a particle size distribution, determined by particle size analysis using Retsch equipment, as follows:
from 0 to 1% by weight of particles >400 microns,
from 40% to 45% by weight of particles between 250 and 400 microns,
from 48% to 53% by weight of particles between 100 and 250 microns,
from 3.5% to 8% by weight of particles between 75 and 100 microns, and
from 0 to 2.5% by weight of particles <75 microns, the sum of the various fractions of which being 100% by weight,
optionally, adding a plasticizer and/or a flavoring.

8. The chewing gum obtained by performing the method as claimed in claim 7.

9. The chewing gum as claimed in claim 8, wherein it comprises 2% to 85% (w/w) of said sorbitol powder.

10. A sorbitol powder with a particle size distribution, determined by particle size analysis using Retsch equipment, as follows:
from 0 to 1% by weight of particles >400 microns,
from 40% to 45% by weight of particles between 250 and 400 microns,
from 48% to 53% by weight of particles between 100 and 250 microns,
from 3.5% to 8% by weight of particles between 75 and 100 microns, and
from 0 to 2.5% by weight of particles <75 microns, the sum of the various fractions of which being 100% by weight.
